(19) United States
(12) Patent Application Publication
(10) Pub. No.: US 2023/0155140 A1
(43) Pub. Date: May 18, 2023

(54) METHOD OF PREPARING PLATINUM-BASED ALLOY CATALYST

(71) Applicant: INDUSTRY-ACADEMIC COOPERATION FOUNDATION, YONSEI UNIVERSITY, Seoul (KR)

(72) Inventors: Han Sung KIM, Seoul (KR); Sun Jin PARK, Seoul (KR)

(21) Appl. No.: 18/046,402

(22) Filed: Oct. 13, 2022

(30) Foreign Application Priority Data
Nov. 15, 2021 (KR) 10-2021-0156439

(51) Int. Cl. H01M 4/92

(52) U.S. Cl. CPC H01M 4/921; H01M 4/926

(57) ABSTRACT

A method of preparing a platinum-based alloy catalyst includes preparing a carbon-supported platinum-based alloy catalyst for a fuel cell that may be mass-produced and has high activity and high durability by using an aqueous ozone treatment method.

### CROSS-REFERENCE TO RELATED APPLICATIONS

The present application claims priority to Korean Patent Application No. 10-2021-0156439, filed on Nov. 15, 2021. The entire contents of the above-listed application are hereby incorporated by reference for all purposes.

### TECHNICAL FIELD

The following disclosure relates to a method of preparing a platinum-based alloy catalyst, and more particularly, to a method of preparing a carbon-supported platinum-based alloy catalyst for a fuel cell that may be mass-produced and has high activity and high durability by using an aqueous ozone treatment method.

### BACKGROUND

Platinum is used as a catalyst for a cathode in a fuel cell, which is attracting attention as an eco-friendly energy source, and has excellent performance, but is expensive. The cost of an electrode catalyst is high enough to account for half of the cost of a stack (a device obtained by connecting individual fuel cells in series and parallel), which is the core of a fuel cell system, which is an obstacle to commercialization.

In order to solve this problem, studies on a platinum-based alloy catalyst or a non-platinum-based catalyst have been conducted. It is difficult to actually apply the non-platinum-based catalyst to a fuel cell because its activity is still low. On the other hand, since metals are contained in the platinum-based alloy catalyst in a certain ratio in addition to platinum, it is possible to reduce the amount of platinum used, which may implement an increase in the activity of the catalyst due to the alloying effect.

Studies on alloys of platinum (Pt) and a transition metal (Ti, V, Cr, Fe, Co, Ni, or the like) for the platinum-based alloy catalyst for a fuel cell have been actively conducted. As a method of preparing an alloy catalyst, a co-precipitation method for simultaneously reducing a platinum salt and a transition metal salt is common. According to the co-precipitation method, the platinum is reduced first and the transition metal is reduced later due to a difference in reduction potential, and therefore, a large amount of the transition metal is distributed on a surface of the alloy. In this case, the transition metal is eluted in an acidic atmosphere of the fuel cell, which causes a reduction in performance of the fuel cell.

In order to solve this problem, studies have been actively conducted to prepare a platinum alloy having a core-shell structure including a platinum skin layer that is stable in an acidic atmosphere. In a general method of forming a core-shell structure, a difference in solid diffusion rate between the platinum and the transition metal is used by a heat treatment performed at a high temperature of 700° C. to 1,200° C. However, as agglomeration of catalyst particles becomes intensified and a particle size is increased during the high-temperature heat treatment, an electrochemically active area of the catalyst is decreased, resulting in a reduction in overall catalytic activity.

In order to solve this problem, studies on the preparation of various core-shell type platinum-based alloy catalysts have been conducted. Adzic's research team has prepared a platinum-based monolayer alloy catalyst having a core-shell structure using an under potential deposition (UPD) method, and Strasser's research team has prepared a platinum-based alloy catalyst having a core-shell structure in which a transition metal on a surface is removed using dealloying by an electrochemical method. Although it is possible to prepare a core-shell type alloy catalyst by these methods, it is not easy for mass production in all of these methods because a voltage for each particle should be adjusted by an electrochemical method.

In order to solve this problem, the research team has developed a technology to inhibit a growth of the platinum-based alloy catalyst during the high-temperature heat treatment by introducing an organic polymer material such as polypyrrole or polydopamine as a capping agent (Korean Patent Nos. 10-1231006 and 10-1597970). According to the technologies disclosed in the above patents, when a polymer protective coating to be a material of a carbon layer is formed on a carbon-supported platinum-based alloy catalyst, the protective coating is impregnated with a transition metal, and then the heat treatment is performed, as the protective coating is thermally decomposed, the transition metal in the protective coating diffuses into platinum particles, such that a core-shell structure including a platinum skin layer is formed. In this process, the protective coating plays a role in suppressing the growth of the particles due to agglomeration of the platinum particles.

However, as the high-temperature heat treatment is performed, the polymer protective coating is gradually removed, such that the ability to inhibit the agglomeration is lowered. When the growth of the particles is not sufficiently suppressed, an imbalance between the sizes of the particles occurs. Therefore, the research team has developed a technology that allows the carbon layer to remain thin even after the heat treatment by performing the heat treatment in a hydrogen-deficient condition to sufficiently suppress the growth of the particles, and removes the remaining carbon layer by performing an ozone treatment under a low-temperature (Korean Patent No. 10-2119921).

However, the ozone treatment technology is performed by a dry method in which a catalyst powder is spread on an alumina boat having a limited size inside a quartz tube surrounded by a furnace and ozone is allowed to flow into the quartz tube. In the case of the dry method, an upper layer of the catalyst powder stacked on the boat easily comes into contact with ozone, while a lower layer of the catalyst powder does not easily come into contact with ozone. Therefore, the effect of removing the carbon layer is reduced as the amount of the powder to be subjected to the ozone treatment is increased. As a result, there is a limit to the application of the dry method to mass production.

### SUMMARY

An embodiment of the present disclosure is directed to providing a method of preparing a carbon-supported platinum-based alloy catalyst for a fuel cell that may be mass-produced and has high activity and high durability, a platinum-based alloy catalyst prepared by the preparation method, and an electrode for a fuel cell that comprises the platinum-based alloy catalyst.

Another embodiment of the present disclosure is directed to providing a method of preparing a novel carbon-supported platinum-based alloy catalyst using an aqueous ozone treatment method.

In one general aspect, a method of preparing a platinum-based alloy catalyst comprises:

a first step of preparing a first composite by coating a Pt/C catalyst, obtained by supporting platinum on a carbon support, with an organic polymer;

a second step of preparing a second composite by mixing the first composite and a transition metal precursor;

a third step of performing a heat treatment on the second composite; and

a fourth step of performing an aqueous ozone treatment on the heat-treated second composite.

The fourth step may be a step of performing the aqueous ozone treatment after an acid treatment of the heat-treated second composite.

The carbon support may be crystalline carbon.

The organic polymer may be a nitrogen-containing organic polymer.

The nitrogen-containing organic polymer may be one or two or more selected from the group consisting of polypyrrole, polyaniline, and polydopamine.

The transition metal precursor may comprise one or two or more selected from the group consisting of nickel (Ni), palladium (Pd), copper (Cu), silver (Ag), gold (Au), titanium (Ti), zirconium (Zr), vanadium (V), chromium (Cr), iron (Fe), ruthenium (Ru), cobalt (Co), and rhodium (Rh).

The transition metal precursor may comprise a nickel (Ni) precursor and a cobalt (Co) precursor.

A molar ratio of the nickel precursor, the cobalt precursor, and the platinum may be 1:0.7 to 1.3:3 to 6.

The heat treatment in the third step may be performed at 700° C. to 1,200° C. in a reducing atmosphere.

In the fourth step, after the heat-treated second composite is added to a reactor together with water, ozone gas may be supplied.

The fourth step may be performed at 80° C. or lower.

In the fourth step, after the heat-treated second composite is added to a vertical fluidized bed reactor together with water, ozone gas may be supplied.

In another general aspect, there is provided a platinum-based alloy catalyst prepared by the method of preparing a platinum-based alloy catalyst.

The platinum-based alloy catalyst may comprise a core containing a transition metal and a shell disposed on the core and containing platinum.

The transition metal may comprise nickel (Ni) and cobalt (Co).

A molar ratio of the nickel, the cobalt, and the platinum may be 1:0.7 to 1.3:3 to 6.

The shell may have a concentration gradient in which a concentration of the platinum is decreased toward the core.

In still another general aspect, an electrode for a fuel cell comprises the platinum-based alloy catalyst.

Other features and aspects will be apparent from the following detailed description and the drawings.

### BRIEF DESCRIPTION OF THE FIGURES

FIG. 1 is a schematic view illustrating a method of preparing a platinum-based alloy catalyst according to Example 1.

FIG. 2 is a schematic view illustrating a vertical-aqueous ozone treatment method performed in Step 5 of FIG. 1 in detail, a reaction formula of a carbon oxidation reaction occurring in a carbon layer during the vertical-aqueous ozone treatment, and removal of the carbon layer according to the reaction formula.

FIG. 3 is a transmission electron microscope (TEM) photograph of the catalyst prepared in Example 1.

FIG. 4 illustrates a high angle annular dark field (HAADF) image of the catalyst prepared in Example 1, and a graph of an energy dispersive spectroscopy (EDS) line scan showing a concentration distribution of platinum (Pt), nickel (Ni), and cobalt (Co) in the gray solid line on the image.

FIG. 5 is a graph of cyclic voltammetry (CV) measured by applying the catalyst prepared in each of Comparative Example 1 and Example 1 to a rotating disk electrode (RDE).

FIG. 6 is a graph of linear sweep voltammetry (LSV) measured by applying the catalyst prepared in each of Comparative Example 1 and Example 1 to the RDE.

FIG. 7 is a schematic view illustrating an ozone treatment process performed in Comparative Example 2.

FIG. 8 is a graph obtained by calculating an electrochemical surface area (ECSA) in the CV measured by applying, to the RDE, the catalyst prepared by varying the temperature to 25° C., 50° C., and 100° C. during the ozone treatment in Comparative Example 2.

FIG. 9 is a schematic view of a heat treatment boat in a furnace quartz tube used for the ozone treatment for removing a carbon layer in Comparative Example 3.

FIG. 10 is a graph showing an IV polarization curve of a membrane electrode assembly (MEA) prepared by using the catalyst prepared by varying the amount of catalyst per batch to 35 mg, 175 mg, and 500 mg during the ozone treatment in Comparative Example 3 as a cathode surface.

FIG. 11 is a graph showing an IV polarization curve of an MEA prepared by using the catalyst prepared by varying the amount of catalyst per batch to 35 mg and 1,000 mg during the ozone treatment in Example 1 as a cathode surface.

FIG. 12 is a graph showing an IV polarization curve of an MEA prepared by using the catalyst prepared in each of Comparative Example 4 and Example 1 as a cathode surface.

FIG. 13 is a graph showing mass activity per weight of an MEA prepared by using the catalyst prepared in each of Comparative Example 5 and Example 1 as a cathode surface.

FIG. 14 is a graph showing an IV polarization curve of an MEA prepared by using the catalyst prepared in each of Comparative Example 5 and Example 1 as a cathode surface and doubling a loading amount in Comparative Example 5 compared to that in Example 1.

### DETAILED DESCRIPTION

As a result of repeated studies on a method of preparing a catalyst for a fuel cell having higher activity and high durability and reproducibility, the present inventors have devised a technology for preparing a novel platinum-based catalyst to solve problems such as agglomeration of platinum particles.

Hereinafter, the present disclosure will be described in detail.

Meanwhile, exemplary embodiments of the present disclosure may be modified in many different forms and the scope of the invention should not be limited to the exemplary embodiments set forth herein. In addition, the exemplary embodiments of the present disclosure are provided so that those skilled in the art may more completely understand the present disclosure. In addition, unless the context clearly indicates otherwise, singular forms used in the specification and the scope of the present disclosure are intended to include plural forms. Furthermore, in the entire specification, unless explicitly described otherwise, “comprising” any components will be understood to imply the inclusion of other components but not the exclusion of any other components.

In the present specification, it will be understood that when an element such as a layer, a film, a region, a plate, or the like, is referred to as being “on” or “above” another element, it may be directly on another element or may have an intervening element present therebetween.

A method of preparing a platinum-based alloy catalyst according to an exemplary embodiment of the present disclosure may comprise:

a first step of preparing a first composite by coating a Pt/C catalyst, obtained by supporting platinum on a carbon support, with an organic polymer;

a second step of preparing a second composite by mixing the first composite and a transition metal precursor;

a third step of performing a heat treatment on the second composite; and

a fourth step of performing an aqueous ozone treatment on the heat-treated second composite.

The first step is a step of preparing a Pt/C catalyst coated with an organic polymer, that is, a first composite. In this case, the organic polymer may be a nitrogen-containing organic polymer, and specifically, the nitrogen-containing organic polymer may be one or two or more selected from the group consisting of polypyrrole, polyaniline, and polydopamine, but is not limited thereto.

In this case, the Pt/C catalyst obtained by supporting platinum on a carbon support may not be limited even when a catalyst is prepared by those skilled in the art or a commercially available catalyst is used.

According to an exemplary embodiment of the present disclosure, the Pt/C catalyst coated with an organic polymer, that is, the first composite may be prepared by immersing the Pt/C catalyst obtained by supporting platinum on a carbon support in a solution containing a monomer of the organic polymer and performing self-polymerization. Accordingly, agglomeration of alloy catalyst particles in a heat treatment to be described below may be suppressed, and an efficient core-shell structure alloying process may be performed.

The monomer of the organic polymer may be contained, for example, in an amount of 0.1 to 1.5 parts by weight, 0.5 to 1.0 part by weight, or 0.8 parts by weight, with respect to 100 parts by weight of the solution. The Pt/C catalyst obtained by supporting platinum on a carbon support may be contained, for example, in an amount of 0.5 to 2.0 parts by weight, 0.8 to 1.5 parts by weight, 1.0 to 1.3 parts by weight, or 1.17 parts by weight, with respect to 100 parts by weight of the solution. The amounts of the monomer of the organic polymer and the Pt/C catalyst may be appropriately changed within the limit to achieve the object of the present disclosure.

The solution may be a buffer solution, such as a tris-buffer solution having a pH of 8 to 10. In terms of causing an efficient self-polymerization reaction of the monomer of the organic polymer, a tris-buffer solution having a pH of 8 to 9, or a pH of 8.5, may be used.

The support used for preparing the platinum-based alloy catalyst according to an exemplary embodiment of the present disclosure may be a common carbon support used as a support capable of supporting a metal. The carbon support may be crystalline carbon, and the crystalline carbon may be one or two or more selected from the group consisting of a carbon nanotube (CNT), a carbon nanofiber (CNF), a carbon nanocoil, and a carbon nanocage (CNC), but the present disclosure is not particularly limited to the selection of the carbon support.

The second step is a step of preparing a second composite by introducing a transition metal precursor into the first composite. In the second step, the first composite may be mixed in a solution prepared by dissolving the transition metal precursor in a solvent. Accordingly, an organic polymer coating layer of the first composite may act like a sponge to absorb the transition metal precursor. In this case, the transition metal precursor may be contained, for example, in an amount of 10 to 50 parts by weight, specifically, 20 to 40 parts by weight, and more specifically, 20 to 35 parts by weight, with respect to 100 parts by weight of the first composite, but the amount of the transition metal precursor is not limited to the above range. The content of the transition metal precursor may be appropriately changed in consideration of the number of precursors used, the type of salt, the composition of the alloy, and the like.

The solvent for dissolving the transition metal precursor may be, but is not limited to, one or more selected from the group consisting of distilled water, acetone, dimethylformamide (DMF), octanol, and ethoxy ethanol.

The transition metal precursor may comprise one or two or more selected from the group consisting of nickel (Ni), palladium (Pd), copper (Cu), silver (Ag), gold (Au), titanium (Ti), zirconium (Zr), vanadium (V), chromium (Cr), iron (Fe), ruthenium (Ru), cobalt (Co), and rhodium (Rh). Specifically, the transition metal precursor may comprise one or more selected from nitrate, sulfate, acetate, chloride, and oxide comprising the above metal, and may comprise nitrate of the above metal, but the present disclosure is not limited thereto.

In an exemplary embodiment of the present disclosure, the transition metal precursor may be a precursor comprising one kind of metal, and may be a precursor comprising two or more kinds of metals. Specifically, the transition metal precursor may comprise a nickel (Ni) precursor and a cobalt (Co) precursor, and may be, for example, nickel nitrate and cobalt nitrate, but the present disclosure is not limited thereto.

In an exemplary embodiment, a molar ratio of the transition metal precursor and the platinum may be, for example, 1:1 to 1:4, 1:1 to 1:3, or 1:2.

In an exemplary embodiment, a molar ratio of the nickel precursor and the cobalt precursor may be 1:0.7 to 1:1.3 in terms of realizing further improved catalytic activity, and may be 1:0.8 to 1:1.2 or 1:0.9 to 1:1.1.

In an exemplary embodiment, a molar ratio of the nickel precursor, the cobalt precursor, and the platinum may be 1:0.7 to 1.3:3 to 6 in terms of preparing a catalyst having further improved catalytic activity, or may be 1:0.8 to 1.2:3.5 to 5.5 or 1:0.9 to 1.1:3.5 to 4.5.

The third step is a step of performing a heat treatment on the second composite, and the heat treatment may be performed in a reducing atmosphere at 700° C. to 1,200° C., specifically, 750° C. to 1,000° C., and more specifically, 850° C. to 950° C. A heat treatment time may be appropriately changed according to the temperature or the surrounding environment, and the heat treatment may be performed for 0.5 hours to 4 hours or 1 hour to 3 hours.

Specifically, the reducing atmosphere may be a mixed atmosphere of an inert gas and hydrogen gas, and a volume ratio of the hydrogen gas and the inert gas may be 1:7 to 10, but is not limited thereto.

In an exemplary embodiment of the present disclosure, the heat treatment may be performed using a known reactor. As an example, the heat treatment may be performed in a movable tube furnace, but is not limited thereto within the scope of achieving the object of the present disclosure.

The heat treatment is performed under the above conditions, such that the organic polymer coating layer in the second composite may be converted into a carbon layer, and the carbon layer may effectively suppress a growth of a size of the catalyst particles caused during the heat treatment. In addition, the heat treatment is performed under the above conditions, such that a catalyst having a core-shell structure in which a platinum skin layer is formed on a surface of the catalyst while the transition metal deposited in the second step is diffused into the platinum particles through particle rearrangement may be formed.

The fourth step is a step of performing an aqueous ozone treatment on the heat-treated second composite to remove the carbon layer, and specifically, in the fourth step, after the heat-treated second composite is added to the reactor together with water, ozone gas may be supplied.

The ozone treatment may be performed by a vertical-aqueous ozone treatment method and specifically, the ozone treatment may be performed by supplying ozone gas after adding water and the heat-treated second composite to a vertical fluidized bed reactor.

In this case, an ozone treatment temperature may be set to 80° C. or lower, and specifically, may be 10° C. to 80° C., 20° C. to 70° C., 20° C. to 60° C., or 20° C. to 40° C. In addition, an ozone treatment time may vary depending on the amount of the catalyst, and may be, for example, 10 minutes to 10 hours or 10 minutes to 3 hours.

The existing ozone treatment method is a dry method, and specifically, the ozone treatment is performed by a dry method in which a catalyst powder is spread on an alumina boat having a limited size inside a quartz tube surrounded by the furnace and ozone is allowed to flow into the quartz tube. Accordingly, an upper layer of the catalyst powder stacked on the boat easily comes into contact with ozone, while a lower layer of the catalyst powder does not easily come into contact with ozone. Therefore, there is a disadvantage that the effect of removing the carbon layer is reduced as the amount of the powder to be subjected to the ozone treatment is increased.

On the other hand, the ozone treatment method according to an exemplary embodiment of the present disclosure is an aqueous ozone treatment method in which the heat-treated second composite is introduced into the reactor together with water and ozone gas is supplied. Since the contact between the introduced second composite and the ozone gas may be increased, the contact between the ozone gas and the catalyst is increased, such that the effect of removing the carbon layer coating the catalyst may be improved. In addition, a reaction in which carbon is oxidized by ozone gas in water is promoted, such that the carbon layer may be removed uniformly and quickly.

Specifically, the fourth step may be performed by a vertical-aqueous ozone treatment method in which ozone gas is supplied after the heat-treated second composite is added to a vertical fluidized bed reactor together with water. More specifically, in the ozone treatment, a vertical fluidized bed reactor is introduced, the catalyst and water are added to the reactor together, and ozone gas is allowed to flow from the bottom to the top, such that the reaction may be performed while the aqueous catalyst solution inside the reactor is mixed up and down by the ozone gas. Accordingly, as the contact between the ozone gas and the catalyst is further increased, the effect of removing the carbon layer coating the catalyst is further improved. In addition, the ozone treatment is performed in water, such that a reaction in which carbon is oxidized by ozone gas in water may be promoted, and thus the carbon layer may be removed more uniformly and quickly.

In an exemplary embodiment of the present disclosure, the fourth step may be a step of performing the aqueous ozone treatment after an acid treatment of the heat-treated second composite to remove the transition metal remaining in the carbon layer. That is, after the heat treatment, an acid treatment may be further included, and in the acid treatment, the remaining transition metal serving as a catalyst for reforming the carbon layer during the ozone treatment is removed, such that the effect of removing the carbon layer in the ozone treatment may be further improved.

In the acid treatment, leaching may be performed using an acidic solution. For example, the acid treatment may be performed using an acidic solution, for example, at a concentration of 0.1 M to 5 M, 0.1 M to 3 M, or 0.5 M, at 60° C. to 100° C. or 80° C. for 3 hours. In this case, the acidic solution may contain an inorganic acid, such as sulfuric acid, but the present disclosure is not limited thereto.

A platinum-based alloy catalyst according to an exemplary embodiment of the present disclosure may be prepared by the preparation method described above, and the platinum-based alloy catalyst may be a core-shell composite comprising a core containing a transition metal and a shell disposed on the core and containing platinum.

The platinum-based alloy catalyst may be a catalyst supported to a carbon support, and the carbon support described above may be applied.

The core contains a transition metal, such that activation energy of an intermediate reaction product may be lowered by modifying a physical structure and an electronic structure of the platinum through alloying with the platinum contained in the shell. Accordingly, the activity of the catalyst may be increased, and the amount of expensive platinum used may be reduced.

The transition metal of the core may be one or two or more selected from the group consisting of nickel (Ni), palladium (Pd), copper (Cu), silver (Ag), gold (Au), titanium (Ti), zirconium (Zr), vanadium (V), chromium (Cr), iron (Fe), ruthenium (Ru), cobalt (Co), and rhodium (Rh). The transition metal of the core may comprise nickel and cobalt, such that the catalyst may have more excellent catalytic activity and improved durability.

A molar ratio of the transition metal and the platinum in the core-shell composite may be, for example, 1:1 to 1:4, 1:1 to 1:3, or 1:2, in terms of effectively implementing the above effect.

In a case where the transition metal of the core comprises nickel and cobalt, a molar ratio of the nickel, the cobalt, and the platinum may be 1:0.7 to 1.3:3 to 6 in terms of implementing improved catalytic activity, or may be 1:0.8 to 1.2:3.5 to 5.5.

The shell may contain platinum as a main component, and the shell may have a concentration gradient in which a concentration of the platinum is decreased toward the core. Therefore, elution of the transition metal may be effectively suppressed.

An electrode for a fuel cell according to an exemplary embodiment of the present disclosure may comprise the platinum-based alloy catalyst.

Hereinafter, Preparation Examples, Examples, and Experimental Examples of the present disclosure will be described below in detail. In addition, the present disclosure will be described in detail with reference to the accompanying drawings in order to assist in the understanding of the present disclosure. However, the following descriptions of Preparation Examples, Examples, and Experimental Examples are merely illustrative of a part of the present disclosure, and the present disclosure is not limited thereto.

### Preparation Example 1: Preparation of Carbon-Supported Platinum (Pt/C) Catalyst

50 mg of 1-pyrene carboxylic acid (1-PCA) and 100 mg of crystalline carbon were dispersed in 20 ml of ethanol, and stirring was performed for 2 hours. After the stirring, 1-PCA-doped crystalline carbon was recovered using a reduced pressure filtration device. This step is to make a surface of the crystalline carbon hydrophilic by 71-71 interaction between the 1-PCA and the crystalline carbon to facilitate support of platinum.

110 mg of the 1-PCA-doped crystalline carbon was added to 25 ml of ethylene glycol, and stirring was performed for 10 minutes. 160 mg of PtCl₄ was added to the stirred solution, and stirring was performed for 30 minutes. After completion of the stirring, 75 mg of sodium hydroxide (NaOH) was added to adjust the pH to lower a platinum particle size, and stirring was performed for 30 minutes. After the sodium hydroxide was dissolved, refluxing was performed at 160° C. for 10 minutes using a microwave. At this time, platinum ions were reduced and adsorbed to the crystalline carbon surface. After the refluxing, in order to increase a platinum supporting rate, stirring was performed at room temperature for 12 hours, the pH was lowered to 2, and then stirring was performed again for 24 hours. After completion of the stirring, the reaction solution was filtered using a reduced pressure filtration device to recover a solid, the solid was washed three times using ultrapure water, and then the washed solid was dried at 80° C. for 3 hours to remove impurities, thereby obtaining a 48 wt % carbon-supported platinum (Pt/C) catalyst.

### Example 1: Preparation of Carbon-Supported Ternary Alloy Catalyst in which Platinum, Nickel, and Cobalt are Supported

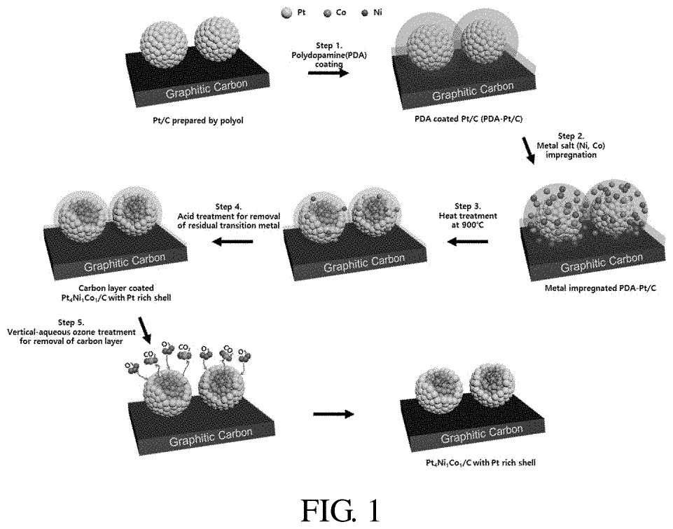

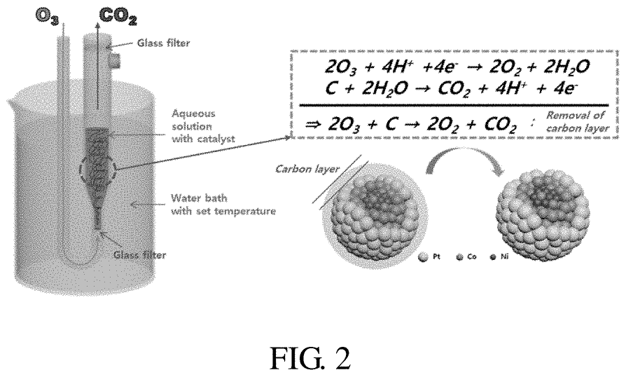

FIG. 1 is a schematic view illustrating a method of preparing a platinum-based alloy catalyst according to Example 1. FIG. 2 is a schematic view illustrating a vertical-aqueous ozone treatment method performed in Step 5 of FIG. 1 in detail, a reaction formula of a carbon oxidation reaction occurring in a carbon layer during the vertical-aqueous ozone treatment, and removal of the carbon layer according to the reaction formula.

As illustrated in FIG. 1, a carbon-supported platinum (Pt/C) catalyst is coated with polydopamine (PDA) as a capping agent (Step 1), nickel (Ni) and cobalt (Co) precursors are deposited (Step 2), and then a high-temperature heat treatment is performed in a hydrogen atmosphere to prepare an alloy (Step 3). Ni and Co remaining in a carbon layer formed at the end of the heat treatment are removed through an acid treatment (Step 4). After the acid treatment, an ozone treatment is performed in an aqueous catalyst solution using a vertical fluidized bed reactor to effectively remove the carbon layer (Step 5). Hereinafter, specific experimental methods for each step will be described.

Step 1: 121 mg of trisaminomethane was added to 100 ml of deionized water, stirring was performed for 1 hour, 0.5 M HCl was added by 0.2 ml each using a micropipette to adjust the pH to 8.5, and then stirring was performed additionally for 2 hours, thereby preparing a tris-buffer solution having a pH of 8.5.

175 mg of the Pt/C catalyst prepared in Preparation Example 1 was added to 25 ml of the tris-buffer solution (25° C.) having a pH of 8.5, stirring was performed for 30 minutes, a solution obtained by dissolving 120 mg of dopamine hydrochloride in 15 ml of the tris-buffer solution was added to a solution to which the Pt/C catalyst was added, and then stirring was performed again for 24 hours. At this time, a catalyst having the amount of platinum supported of 48% was used the Pt/C catalyst.

Thereafter, the product was recovered using a reduced pressure filtration device, and the product was washed twice using deionized water. Then, the product was dried in an oven at 80° C. for 30 minutes to prepare a first composite, that is, Pt/C coated with polydopamine (PDA).

Step 2: 31.1 mg of nickel nitrate (Ni(NO₃)₂.6H₂O) and 31.2 mg of cobalt nitrate (Co(NO₃)₂·6H₂O) were added to 20 ml of deionized water, stirring was sufficiently performed, the first composite prepared in Step 1 was added, and then refluxing was performed at 80° C. for 3 hours. Thereafter, the deionized water was evaporated using an evaporator, and a second composite was recovered.

Step 3: The second composite prepared in Step 2 was spread evenly on an alumina boat, the alumina boat was placed in a quartz tube surrounded by a furnace, and a heat treatment was performed at 900° C. in an atmosphere containing 90 vol % of argon and 10 vol % of hydrogen for 2 hours. In order to have the heat treatment effect on the alumina boat only during the heat treatment for 2 hours, the alumina boat was pushed aside along the quartz tube until before the furnace body reached a target temperature of 900° C., and when the furnace body reached the target temperature, the heat treatment was performed so that the center of the furnace body coincided with the center of the alumina boat. After 2 hours of the heat treatment, the alumina boat was pushed aside again so that the alumina boat was cooled. At this time, hydrogen was allowed to flow only for 2 hours when the center of the furnace body coincided with the center of the alumina boat, and an atmosphere of 100% of argon was maintained. After the alumina boat was completely cooled, Pt₄Ni₁Co₁/C with a carbon layer protective coating was recovered.

Step 4: In order to perform an acid treatment on the second composite heat-treated in Step 3, refluxing was performed in 0.5 M H₂SO₄ at 80° C. for 3 hours. Thereafter, the product was recovered using a reduced pressure filtration device, and the product was washed twice using deionized water. Then, the remaining transition metal was removed by drying the product in an oven at 80° C. for 30 minutes, and Pt₄Ni₁Co₁/C with a carbon layer protective coating was recovered.

Step 5: The Pt₄Ni₁Co₁/C prepared in Step 4 was added to the vertical fluidized bed reactor illustrated in FIG. 2 together with 10 ml of water. The vertical fluidized bed reactor was placed in a beaker containing water set at 30° C. and ozone gas was allowed to flow for 30 minutes. At this time, the amount of water and treatment time during the ozone treatment may vary depending on the amount of catalyst, and the ozone treatment temperature may be set to 80° C. or lower. After the ozone treatment, a product was recovered using a reduced pressure filtration device, the product was dried in an oven at 80° C. for 30 minutes, and then Pt₄Ni₁Co₁/C was recovered, thereby preparing a catalyst.

### Comparative Example 1

A catalyst was prepared by performing Steps 1 to 4 without performing Step 5 in Example 1.

### Comparative Example 2

A catalyst was prepared by performing the catalyst preparation in the order of Steps 3, 5, and 4 in Example 1.

### Comparative Example 3

A catalyst was prepared by performing the ozone treatment in a dry environment using a heat treatment boat in a furnace quartz tube instead of the vertical fluidized bed reactor used for the ozone treatment for removing the carbon layer in Example 1.

### Comparative Example 4: Carbon-Supported Binary Alloy Catalyst in which Platinum and Nickel are Supported

In Comparative Example 4, a Pt₂Ni₁/C alloy with a carbon layer protective coating was prepared by the preparation method of Example 1 of U.S. Pat. No. 10,038,200 and Korean Patent No. 10-2119921, the Pt₂Ni₁/C alloy being prepared by coating the Pt/C catalyst prepared in Preparation Example 1 with PDA, depositing a Ni precursor (64 mg of nickel nitrate (Ni(NO₃)₂·6H₂O), and then performing a heat treatment in an atmosphere containing 95 vol % of argon and 5 wt % of hydrogen. After the heat treatment, an ozone treatment was performed in a dry environment using a heat treatment boat in a furnace quartz tube to remove the carbon layer protective coating, and then an acid treatment was performed, thereby finally preparing a catalyst.

### Comparative Example 5

In Comparative Example 5, the Pt/C catalyst prepared in Preparation Example 1 was used.

### Experimental Example 1: Confirmation of Catalyst Having Core-Shell Structure

In Experimental Example 1, in order to confirm the core-shell structure having the small and even particles formed by the protective coating heat treatment effect and the platinum skin layer, the catalyst prepared in Example 1 was analyzed using a transmission electron microscope (TEM) and an energy dispersive spectroscopy (EDS) line scan.

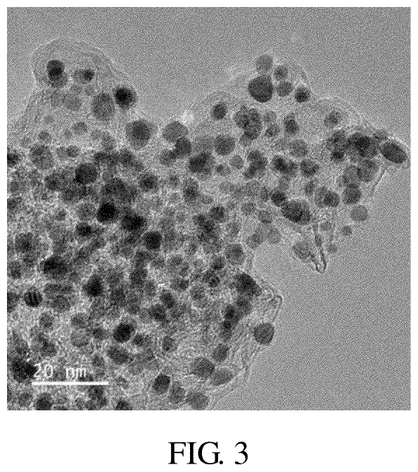

FIG. 3 illustrates a TEM photograph of the catalyst prepared in Example 1, and shows that particles of about 5 nm are evenly distributed even after the heat treatment due to the protective coating effect.

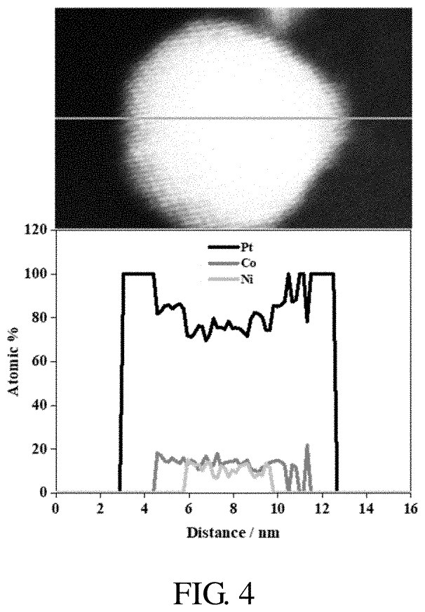

The upper image of FIG. 4 is a high angle annular dark field (HAADF) image of the catalyst prepared in Example 1. The lower image of FIG. 4 is a graph of the energy dispersive spectroscopy (EDS) line scan showing a concentration distribution of platinum (Pt), nickel (Ni), and cobalt (Co) in the gray solid line on the image. Referring to FIG. 4, it could be appreciated that due to the surface separation phenomenon by the heat treatment, nickel and cobalt were concentrated to form a core, and a catalyst having a platinum skin layer was prepared.

### Experimental Example 2: Confirmation of Effect of Removing Carbon Layer According to Vertical-Aqueous Ozone Treatment

Experimental Example 2 is an experiment in which cyclic voltammetry (CV) and linear sweep voltammetry (LSV) are measured by applying the catalyst prepared in Example 1 and the catalyst prepared in Comparative Example 1 to a rotating disk electrode (RDE) in order to confirm the vertical-aqueous ozone treatment effect.

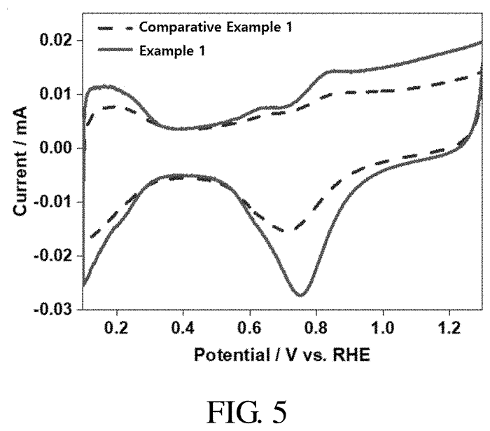

FIG. 5 is a graph obtained by applying the catalysts prepared in Example 1 and Comparative Example 1 to the RDE and measuring and comparing the CVs under a nitrogen saturation condition. The CV is used to measure an electrochemical surface area (ECSA) of the catalyst, and a magnitude of a platinum-hydrogen adsorption/desorption peak is proportional to the ECSA of the catalyst. In Comparative Example 1 in which the ozone treatment was not performed, the carbon layer was thin, and thus the hydrogen adsorption/desorption peak on the platinum surface was small. On the other hand, in Example 1 in which the ozone treatment was performed, the carbon layer was removed, and thus the hydrogen adsorption/desorption peak on the platinum surface was large.

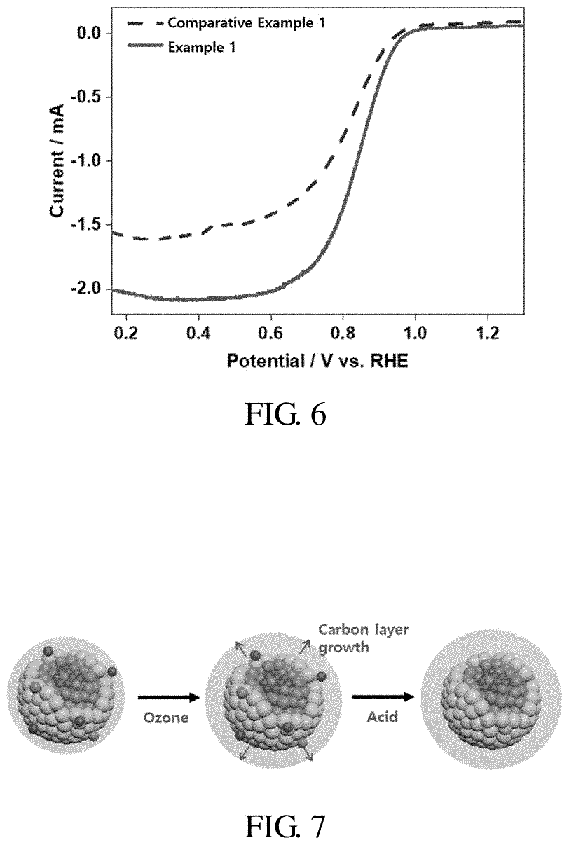

FIG. 6 is a graph showing comparison of CVs measured by applying the catalysts prepared in Example 1 and Comparative Example 1 to the RDE and LSVs measured by rotating the electrode at a speed of 2,500 rpm under an oxygen saturation condition. The LSV measured under the oxygen saturation condition is used to measure activity for an oxygen reduction reaction (ORR), and as an on-set potential at which oxygen starts to be reduced is increased, a two-electron reaction in which H₂O₂ is generated occurs less often. Therefore, as a limiting current density is increased, the activity of the ORR is more excellent. In Comparative Example 1 in which the ozone treatment was not performed, the activity of the ORR was small. On the other hand, in Example 1 in which the ozone treatment was performed, the carbon layer was effectively removed, and thus the activity of the ORR was large.

In particular, when the vertical fluidized bed reactor illustrated in FIG. 2 is introduced, the catalyst and water are added to the reactor together, and ozone gas is allowed to flow from the bottom to the top, the reaction is performed while the aqueous catalyst solution inside the reactor is mixed up and down by the ozone gas. At this time, since a mechanism in which ozone and carbon react according to the reaction formula of FIG. 2 to remove the carbon layer, when water is present, the carbon oxidation reaction is promoted by the ozone, such that the carbon layer may be removed uniformly and quickly.

### Experimental Example 3: Confirmation of Effect of Removing Carbon Layer During Ozone Treatment According to Order of Acid Treatment

Experimental Example 3 is an experiment in which CV is measured by applying the catalyst prepared in each of Comparative Example 2 and Example 1 to the RDE to calculate the ECSA.

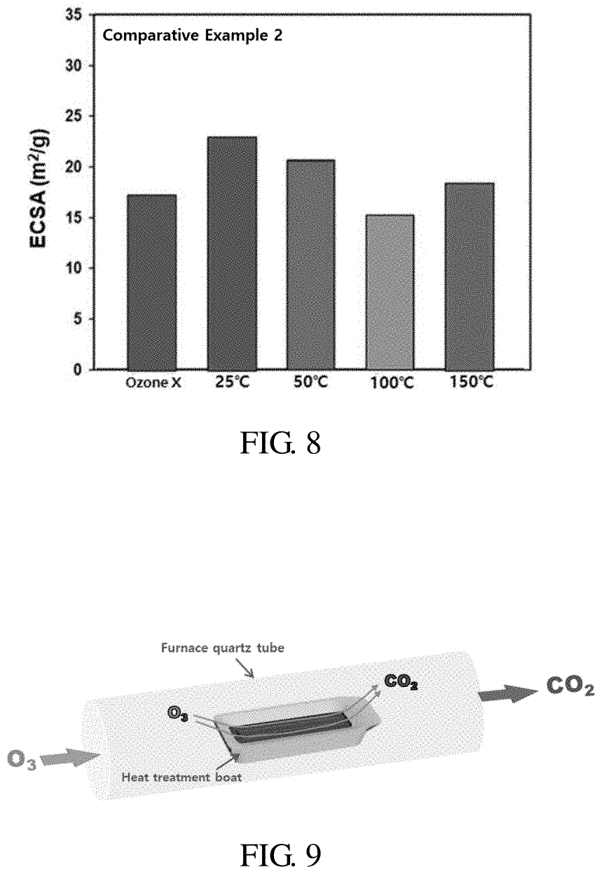

FIG. 7 is a schematic view illustrating a growth of the carbon layer due to the catalytic effect of the Ni and Co metals remaining in the carbon layer when the ozone treatment is performed before the acid treatment according to Comparative Example 2. FIG. 8 is a graph obtained comparing the ECSAs calculated in the CVs measured under a nitrogen saturation condition by applying, to the RDE, the catalyst prepared by varying the temperature during the ozone treatment to 25° C., 50° C., and 100° C. in Comparative Example 2.

FIG. 8 shows that the ECSA is not increased when the temperature is higher than 25° C. during the ozone treatment, and the ECSA tends to be decreased at 100° C. rather than before the ozone treatment. This is because the carbon layer is grown due to the catalytic effect of Ni and Co remaining in the carbon layer.

### Experimental Example 4: Confirmation of Difference in Reproducibility During Scale-Up According to Ozone Treatment Method

Experimental Example 4 is an experiment in which the IV polarization curve of the membrane electrode assembly (MEA) of the catalyst is analyzed, the catalyst being prepared by varying the amount of catalyst per batch during the ozone treatment in Comparative Example 3 and Example 1.

FIG. 9 is a schematic view of a heat treatment boat in a furnace quartz tube used for the ozone treatment for removing the carbon layer in Comparative Example 3.

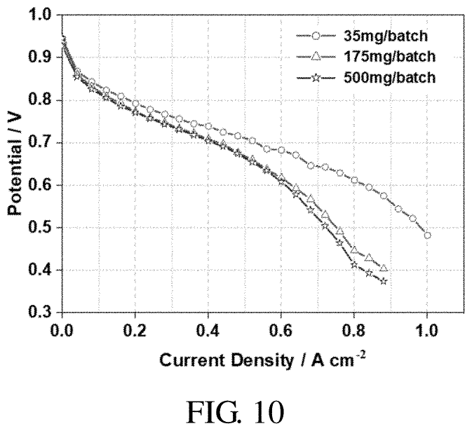

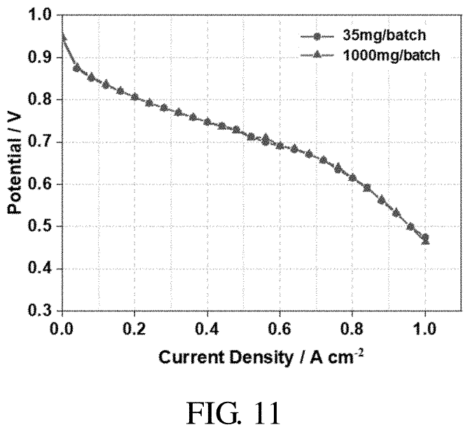

FIG. 10 is a graph showing an IV polarization curve of an MEA prepared by using the catalyst prepared by varying the amount of catalyst per batch to 35 mg, 175 mg, and 500 mg during the ozone treatment in Comparative Example 3 as a cathode surface. FIG. 11 is a graph showing an IV polarization curve of an MEA prepared by using the catalyst prepared by varying the amount of catalyst per batch to 35 mg and 1,000 mg during the ozone treatment in Example 1 as a cathode surface. The comparison of the performance of the MEAs of Comparative Example 3 and Example 1 was performed. The results are shown in Table 1.

TABLE 1

Cell Potential (V)

| | @ 0.6 | @ 0.08 |
|---|---|---|
| Catalyst | A/cm² | A/cm² |
| Comparative Example 3 (35 mg/batch) | 0.6822 | 0.8429 |
| Comparative Example 3 (175 mg/batch) | 0.6173 | 0.8316 |
| Comparative Example 3 (500 mg/batch) | 0.608 | 0.826 |
| Example 1 (35 mg/batch) | 0.69 | 0.845 |
| Example 1 (1,000 mg/batch) | 0.6906 | 0.8451 |

As illustrated in FIG. 10 and shown in Table 1, in the case of the catalyst prepared in Comparative Example 3, as the amount of catalyst per batch was increased, the performance thereof was reduced. In Comparative Example 3, the ozone treatment process was performed by a dry method in which the catalyst powder was spread on an alumina boat having a limited size inside the furnace quartz tube and ozone was allowed to flow into the quartz tube. In the case of the dry method, an upper layer of the catalyst powder stacked on the boat easily comes into contact with ozone, while a lower layer of the catalyst powder does not easily come into contact with ozone. Therefore, there is a disadvantage that the effect of removing the carbon layer is reduced as the amount of the powder to be subjected to the ozone treatment is increased.

On the other hand, as illustrated in FIG. 11 and shown in Table 1, in the case of the catalyst prepared in Example 1, the performance thereof was constant even when the amount of catalyst per batch was increased to 1,000 mg. In Example 1, the vertical fluidized bed reactor was introduced at the time of the ozone treatment, the catalyst and water were added to the reactor together, and ozone gas was allowed to flow from the bottom to the top, and thus the reaction was performed while the aqueous catalyst solution inside the reactor was mixed up and down by the ozone gas. In this process, the contact between the ozone gas and the catalyst is increased, such that the effect of removing the carbon layer is improved. In addition, when water is present, a reaction in which carbon is oxidized by ozone gas is promoted, such that the carbon layer may be removed uniformly and quickly.

### Experimental Example 5: Confirmation of Increase in Performance According to Effect of Tri-Alloy and Preparation Method

Experimental Example 5 is an experiment in which the IV polarization curve of the membrane electrode assembly (MEA) of the catalyst prepared in each of Comparative Example 4 and Example 1 is analyzed.

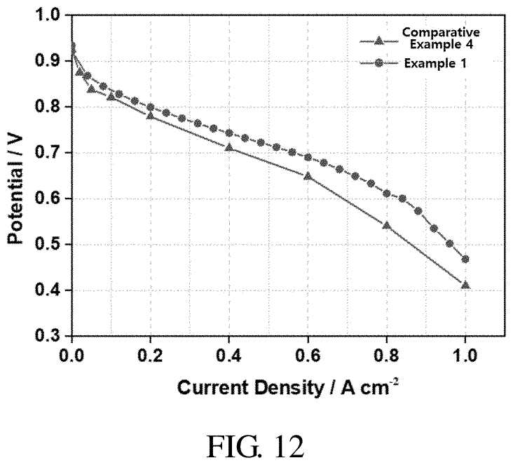

FIG. 12 is a graph obtained by comparing the IV polarization curves of the MEAs prepared by using the binary alloy catalyst (Pt₂Ni₁/C) prepared in Comparative Example 4 and the catalyst prepared in Example 1 as cathode surfaces. The results of measuring the performance and the alloy composition after the acid treatment of the MEAs of Comparative Example 4 and Example 1 with inductively coupled plasma atomic emission spectroscopy (ICP-AES) were compared. The results thereof are shown in Table 2.

TABLE 2

| | Alloy Composi- | | |
|---|---|---|---|
| | tion After Acid | Cell Potential (V) | |
| | Treatment When Mea- | @ 0.6 | @ 0.08 |
| Catalyst | sured by ICP-AES | A/cm² | A/cm² |
| Comparative Example 4 | Pt₂Ni_{0.97} | 0.648 | 0.828 |
| Example 1 | Pt₄Ni_{0.84}Co_{0.82} | 0.69 | 0.845 |

As illustrated in FIG. 12 and shown in Table 2, in Example 1 in which a heterogeneous alloy catalyst was prepared by performing the ozone treatment in a dry environment, it could be confirmed that the performance at both high and low currents was higher due to the vertical-aqueous ozone treatment technology using the vertical fluidized bed reactor and the effect of the tri-alloy of Pt, Ni, and Co, in comparison to Comparative Example 4.

### Experimental Example 6: Confirmation of Improvement of Activity Per Weight of Catalyst Relative to Platinum

Experimental Example 6 is an experiment in which the mass activity per weight and the IV polarization curve of the membrane electrode assembly (MEA) of the catalyst prepared in each of Comparative Example 5 and Example 1 are analyzed.

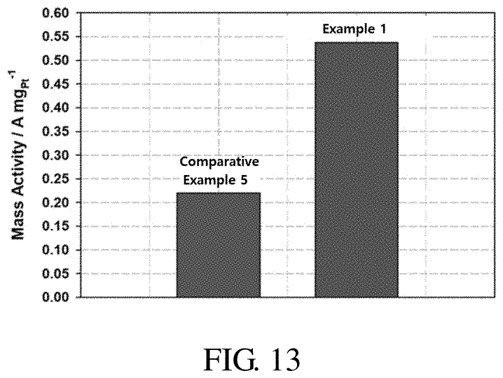

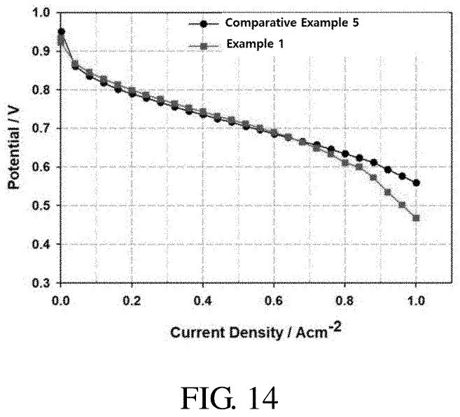

FIG. 13 is a graph showing mass activity per weight of an MEA prepared by using the catalyst prepared in each of Comparative Example 5 and Example 1 as a cathode surface. FIG. 14 is a graph showing an IV polarization curve of an MEA prepared by using the catalyst prepared in each of Comparative Example 5 and Example 1 as a cathode surface and doubling a loading amount in Comparative Example 5 compared to that in Example 1. The comparison of the performance of the MEAs of Comparative Example 5 and Example 1 was performed. The results are shown in Table 3.

TABLE 3

| | |
|---|---|
| Mass Activity | Cell Potential (V) |

| | (A/mg_{Pt}) | @ 0.6 | @ 0.08 |
|---|---|---|---|
| Catalyst | @ 0.9 V | A/cm² | A/cm² |
| Comparative Example 5 | 0.2206 | 0.685 | 0.8344 |
| Example 1 | 0.53784 | 0.69 | 0.845 |

As illustrated in FIG. 13 and shown in Table 3, in the case of the catalyst prepared in Example 1, the mass activity per weight was improved by about 2.5 times greater than that of the catalyst (Pt/C) of Comparative Example 5 due to the vertical-aqueous ozone treatment technology using the vertical fluidized bed reactor and the effect of the tri-alloy of Pt, Ni, and Co.

As illustrated in FIG. 14 and shown in Table 3, although the amount of MEA loaded in Comparative Example 5 was doubled compared to the catalyst prepared in Example 1, in Example 1, the performance was higher at a low current, and the performance was comparable even at a high current.

As can be seen from the above experimental examples, the catalyst prepared by the preparation method according to the present disclosure is prepared by performing the acid treatment before the ozone treatment and then performing aqueous ozone treatment, such that the carbon layer may be more effectively removed, and the catalyst has high activity and high durability for a fuel cell, which is easy for mass production.

As set forth above, the method of preparing a platinum-based alloy catalyst according to the present disclosure comprises a step of coating a carbon-supported platinum-based alloy catalyst with an organic polymer to be a material of a carbon layer, such that it is possible to prepare a core-shell type platinum-based alloy catalyst in which agglomeration of the catalyst is suppressed.

In particular, the method of preparing a platinum-based alloy catalyst according to the present disclosure comprises a step of performing an aqueous ozone treatment, such that the carbon layer may be effectively removed.

Further, the method of preparing a platinum-based alloy catalyst according to the present disclosure comprises a step of performing an acid treatment before the aqueous ozone treatment, such that after the transition metal remaining in the carbon layer is removed, the ozone treatment may be performed to remove the carbon layer more effectively.

Further, in the case of the method of preparing a platinum-based alloy catalyst according to the present disclosure, a binary alloy catalyst, and a ternary alloy catalyst may be formed, such that the amount of platinum used is reduced, and it is possible to prepare a platinum-based alloy catalyst having high activity and high durability.

Therefore, the spirit of the present disclosure should not be limited to the described exemplary embodiments, but the claims and all modifications equal or equivalent to the claims are intended to fall within the spirit of the present disclosure.

1. A method of preparing a platinum-based alloy catalyst, the method comprising:
a first step of preparing a first composite by coating a Pt/C catalyst, obtained by supporting platinum on a carbon support, with an organic polymer;
a second step of preparing a second composite by mixing the first composite and a transition metal precursor;
a third step of performing a heat treatment on the second composite; and
a fourth step of performing an aqueous ozone treatment on the heat-treated second composite.

2. The method of claim 1, wherein the fourth step is a step of performing the aqueous ozone treatment after an acid treatment of the heat-treated second composite.

3. The method of claim 1, wherein the carbon support is crystalline carbon.

4. The method of claim 1, wherein the organic polymer is a nitrogen-containing organic polymer.

5. The method of claim 4, wherein the nitrogen-containing organic polymer is one or two or more selected from the group consisting of: polypyrrole, polyaniline, and polydopamine.

6. The method of claim 1, wherein the transition metal precursor comprises one or two or more selected from the group consisting of: nickel (Ni), palladium (Pd), copper (Cu), silver (Ag), gold (Au), titanium (Ti), zirconium (Zr), vanadium (V), chromium (Cr), iron (Fe), ruthenium (Ru), cobalt (Co), and rhodium (Rh).

7. The method of claim 1, wherein the transition metal precursor comprises a nickel (Ni) precursor and a cobalt (Co) precursor.

8. The method of claim 7, wherein a molar ratio of the Ni precursor, the Co precursor, and the platinum is 1:0.7 to 1.3:3 to 6.

9. The method of claim 1, wherein the heat treatment is performed at 700° C. to 1,200° C. in a reducing atmosphere.

10. The method of claim 1, wherein in the fourth step, after the heat-treated second composite is added to a reactor together with water, ozone gas is supplied.

11. The method of claim 1, wherein the fourth step is performed at 80° C. or lower.

12. The method of claim 10, wherein in the fourth step, after the heat-treated second composite is added to a vertical fluidized bed reactor together with water, ozone gas is supplied.

13. A platinum-based alloy catalyst prepared by the method of preparing a platinum-based alloy catalyst of claim 1.

14. The platinum-based alloy catalyst of claim 13, wherein the platinum-based alloy catalyst comprises a core containing a transition metal and a shell disposed on the core and containing platinum.

15. The platinum-based alloy catalyst of claim 14, wherein the transition metal comprises nickel (Ni) and cobalt (Co).

16. The platinum-based alloy catalyst of claim 15, wherein a molar ratio of the nickel, the cobalt, and the platinum is 1:0.7 to 1.3:3 to 6.

17. The platinum-based alloy catalyst of claim 14, wherein the shell has a concentration gradient in which a concentration of the platinum is decreased toward the core.

18. An electrode for a fuel cell comprising the platinum-based alloy catalyst of claim 13.
